(19) United States
(12) Patent Application Publication
(10) Pub. No.: US 2010/0053456 A1
(43) Pub. Date: Mar. 4, 2010

(54) Mobile Multimedia Terminal Antenna Systems and Methods for Use Thereof

(75) Inventors: Corbett R. Rowell, Mongkok (HK); Chi-Lun Mak, Ma On Shan (HK); Angus C.K. Mak, Shaton (HK)

Correspondence Address: FULBRIGHT & JAWORSKI L.L.P, 2200 ROSS AVENUE, SUITE 2800, DALLAS, TX, 75201-2784, US

(73) Assignee: Hong Kong Applied Science and Technology Research Institute Co., Ltd., Shatin (HK)

(21) Appl. No.: 12/200,843

(22) Filed: Aug. 28, 2008

(51) Int. Cl. H01Q 1/24; H04N 5/455

(52) U.S. Cl. 348/726; 343/702; 348/E05.113

(57) ABSTRACT

A mobile device comprises a main compartment, a flip cover coupled to the main compartment, wherein the main compartment includes a Radio Frequency (RF) feed and ground, and wherein the flip cover includes at least one multiband antenna system in communication with the RF feed and ground, the antenna operating in at least one television broadcast band.

### TECHNICAL FIELD

The present description is related, in general, to systems and methods employing antenna designs and, more specifically, to antenna systems for mobile devices.

### BACKGROUND OF THE INVENTION

Various kinds of mobile devices that receive and/or transmit in the Radio Frequency (RF) spectrum are on the market today. Examples include mobile phones, Personal Digital Assistants (PDAs), email devices, such as BLACKBERRY™-brand devices, mobile televisions/radios, Portable Multimedia Players (PMP), and the like. Each such device includes at least one type of antenna. Antennas for these mobile devices are usually divided into two categories—internal and external.

An external antenna is an antenna that extends outside of the device. For instance, some wire antennas, helical antennas, and monopole antennas are external antennas. Examples include telescoping antennas commonly found in portable stereos and televisions. Other instances of external antennas include pull-out antennas in cell phones. Most external antennas are grounded monopole antennas that use the components within a device, such as a Printed Circuit Board (PCB), as a ground plane. Usually, an external antenna is single-banded and has relatively poor multipath performance. In other words, typical external antenna designs only receive signals of a single polarization, whereas in the multipath environment, the polarization of a signal changes.

By contrast, an internal antenna element is usually contained within a device so that it shares space with the other circuitry of the device, and it is not easy to be seen by the user. One kind of internal antenna includes “miniature” antennas. Examples include dielectric loaded antennas, meander-line antennas, Planar Inverted F Antennas (PIFA), and the like. Internal antenna designs often include multi-band designs and multi-polarized designs, and thus typically provide better multipath performance.

A concern with internal antennas is that they typically compete for space with the other device circuitry. Internal antennas have found favor in high-frequency applications, such as Global System for Mobile communications (GSM) phones. The longest GSM wavelength is about 35 cm, so it is possible to make an internal antenna small enough to fit inside a mobile phone. By contrast, it is difficult to design an internal antenna that operates in the 100 MHz range because the wavelength is over one meter, which, even for a miniaturized antenna, is still too large to fit inside most portable devices. Accordingly, engineers typically use external antennas for low frequency bands, such as the digital television (e.g., 174-240 MHz) and radio bands. A current mobile television on the market uses a pull-out, telescoping, external antenna with an expensive connector that provides swiveling and positioning. Currently, there is no solution available that allows for the reception of television/radio signals with a robust, compact, concealed and low cost antenna system.

### BRIEF SUMMARY OF THE INVENTION

Various embodiments of the present invention include systems and methods employing external antennas that are hidden within screen covers of mobile devices. In one example, a mobile device, providing television reception, includes a screen cover that flips open to reveal the screen and closes to protect the screen. The screen cover conceals an external antenna system that operates at low frequency bands and provides television reception.

Some embodiments of the invention provide multi-band performance, which is often not provided with external antenna designs. Some embodiments also provide multi-polarization performance and, therefore, better multi-path performance than typical external antenna designs.

Advantages of some embodiments of the invention include improved multipath performance, as well as multi-band performance. Also, some embodiments reduce competition for space in the main body of the device. Another advantage of some embodiments is that the space occupied by the cover is much less intrusive than the space occupied by typical wire antennas.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is an illustration of an exemplary system, adapted according to one embodiment of the invention;

FIG. 2 is an exploded view of the system of FIG. 1;

FIG. 3 is an illustration of an exemplary system adapted according to one embodiment of the invention;

FIG. 4 is an illustration of an exemplary system adapted according to one embodiment of the invention;

FIG. 5 is an illustration of an exemplary system adapted according to one embodiment of the invention;

FIG. 6 is an illustration of an exemplary system adapted according to one embodiment of the invention;

FIG. 7 is an illustration of an exemplary system adapted according to one embodiment of the invention;

FIG. 8 is an illustration of an exemplary system adapted according to one embodiment of the invention;

FIG. 9 is an illustration of an exemplary system adapted according to one embodiment of the invention; and

FIG. 10 is an illustration of an exemplary method adapted according to one embodiment of the invention.

### DETAILED DESCRIPTION OF THE INVENTION

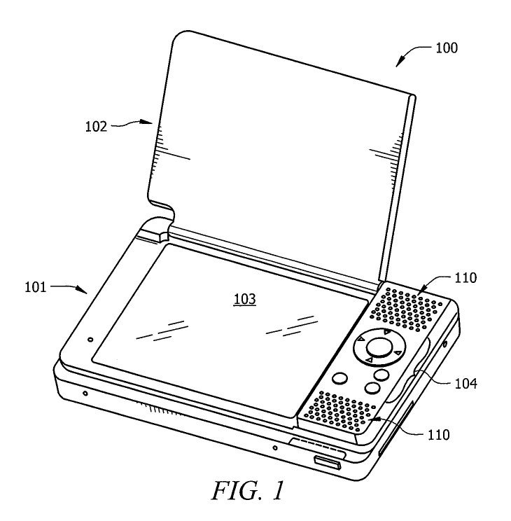

FIG. 1 is an illustration of exemplary system 100, adapted according to one embodiment of the invention. System 100 includes a mobile multimedia terminal that provides, among other things, reception for television and/or radio. System 100 includes main body portion 101, flip cover 102, screen 103, user controls 104 and speakers 110. When a user desires to view television programming, the user opens cover 102 and turns on system 100. System 100 receives the television signal using an antenna (not shown) inside cover 102, and the picture is displayed upon screen 103. System 100 is not limited to television and/or radio, as communication on other frequency bands can also be accommodated. For example, system 100 can be adapted to communicate with a wireless network (e.g., using IEEE 802.11 techniques), a cellular telephone network, or the like.

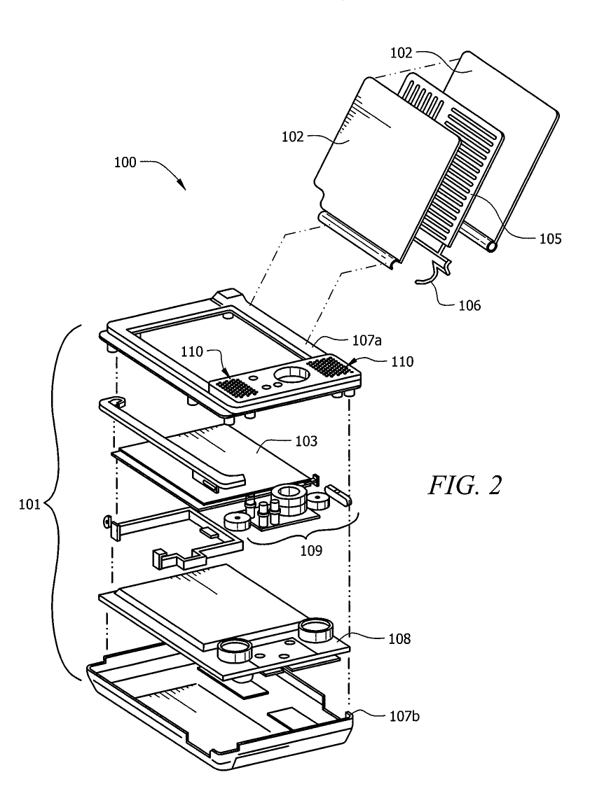

FIG. 2 is an exploded view of system 100. Main body portion 101 includes housing 107, which holds and protects the internal electronic components, such as screen 103, circuit board 108, and transducers 109 . Flip cover 102 has two parts that conceal antenna system 105 therebetween. In this example, antenna system 105 is disposed on a flexible film, which in this example includes a flexible PCB with copper coated on flexible plastic (polyethylene) and a thickness of 0.2 mm. Antenna system 105 is in communication with circuit board 108 through mini-cable 106, and in this example, is a cable that is small enough to pass through the hinge, connecting cover 102 to main body portion 101. Furthermore, since antenna system 105 is located in an area separate from other circuitry it is an external, rather than internal, antenna and does not compete with circuit board 108, screen 103, and transducers 109 for space. In this example, flip cover 102 provides an illusion of a lack of an external antenna.

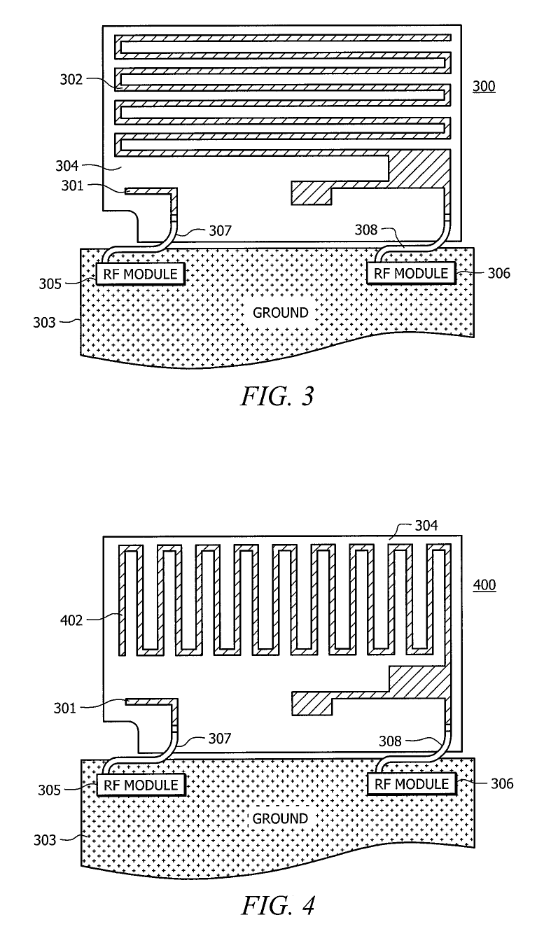

Embodiments of the invention can employ any of a number of antennas and any of a number of connectors, as shown in the following figures. FIG. 3 is an illustration of exemplary system 300, adapted according to one embodiment of the invention. System 300 includes a three-band antenna system located within cover 304. The three-band antenna system includes antenna elements 301 and 302. Antenna element 301 is a single-band element, and it is in communication with Radio Frequency (RF) module 305 through mini-cable 307. RF module 305 is disposed on Printed Circuit Board (PCB) 303, which acts as a ground plane and is located within the module's main body portion. In this example, antenna element 301 is used for Wireless Local Area Network (WLAN) communications or Bluetooth™ communications that operate at Industrial, Scientific and Medical (ISM) band, e.g. 2.4-2.48 GHz.

Antenna element 302 is a dual-band antenna element, which is in communication with RF module 306 through mini-cable 308. Antenna element 302 is used to receive television signals in Band III (174-240 MHz) and L-band (1452-1492 MHz), both of which are used for digital TV reception. However, to conserve space, antenna element 302 is a meander-type element. Thus, the dimensions of cover 304, as well as the dimensions of the mobile device as a whole, can be appropriate for hand-held, portable use. PCB 303 also acts as a ground plane for element 302.

FIG. 4 is an illustration of exemplary system 400 adapted according to one embodiment of the invention. System 400 is another three-band system. In contrast to the system of FIG. 3, system 400 employs a different meander structure for its antenna 402. FIG. 4 illustrates, in a general sense, that the shapes of antennas in various embodiments can be adapted to the specific design constraints of a given system, such as operating bands and cover size.

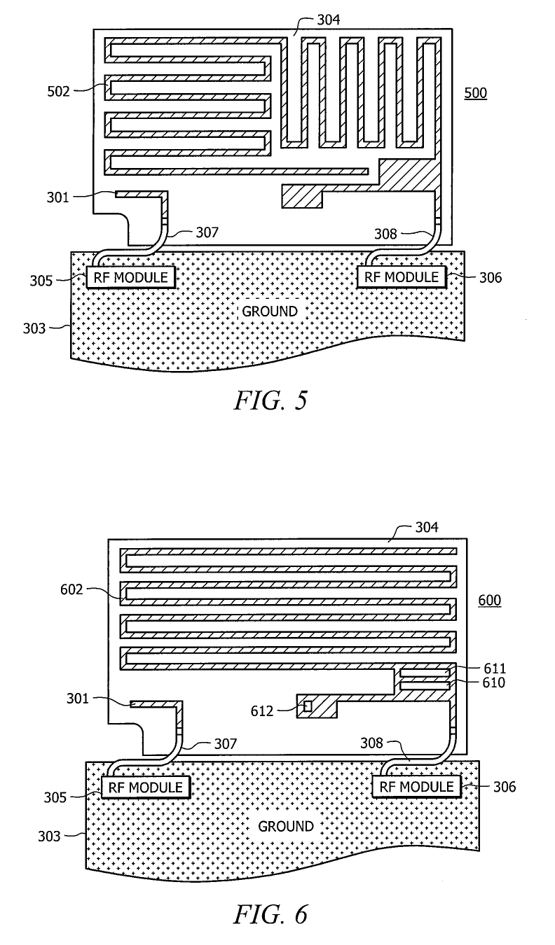

FIG. 5 is an illustration of exemplary system 500 adapted according to one embodiment of the invention. Horizontal-vertical structures, such as structure 502, may be especially useful in some embodiments due to their typically good reception in a multi-path environment.

FIG. 6 is an illustration of exemplary system 600 adapted according to one embodiment of the invention. System 600 is another three-band system, similar to the one shown in FIG. 3. However, system 600 includes the addition of slots 610-612. Slots 610-612 can be used for impedance matching.

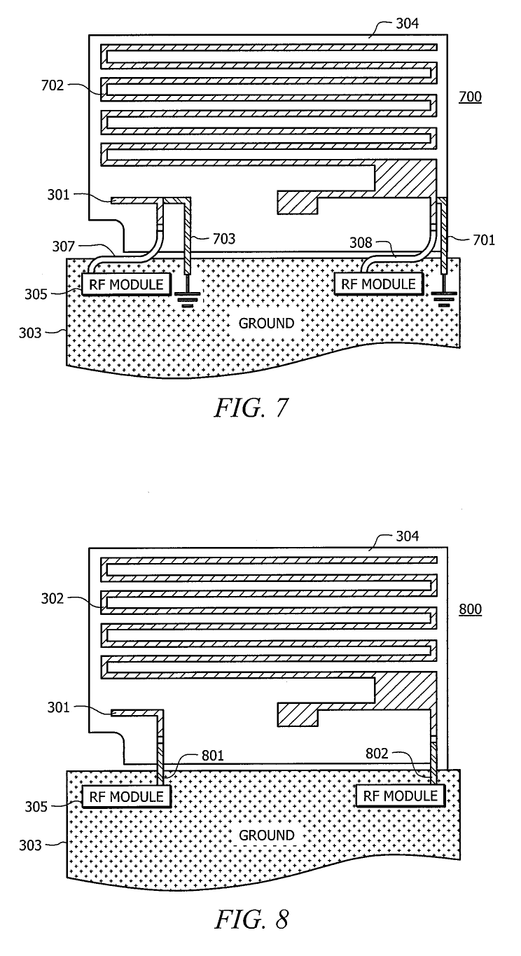

FIG. 7 is an illustration of exemplary system 700 adapted according to one embodiment of the invention. System 700 includes shorting connections 701 and 703. Shorting connections 701 and 703 transform antenna elements 301 and 702 from monopole elements into Planar Inverted F Antenna (PIFA) elements.

FIG. 8 is an illustration of exemplary system 800 adapted according to one embodiment of the invention. System 800 employs flexible traces 801 and 802 instead of mini-cables. In this embodiment, antenna elements 301 and 302 are made of a conductor (usually a metal, such as copper) disposed on a flexible film (shown in FIG. 2) substrate. Some of the conductor and thin portions of the flexible film are extended beyond the flip cover and coupled to RF modules 305 and 306, thereby providing electrical contact thereto. However, flexible traces are not mutually exclusive of mini-cables in a given embodiment, as shown by FIG. 7, which includes mini-cables for feed connections and flexible traces for shorting connections. Any of the features shown above, including slots, shorting connections, and different feed types, can be adapted for use in various embodiments together or separately.

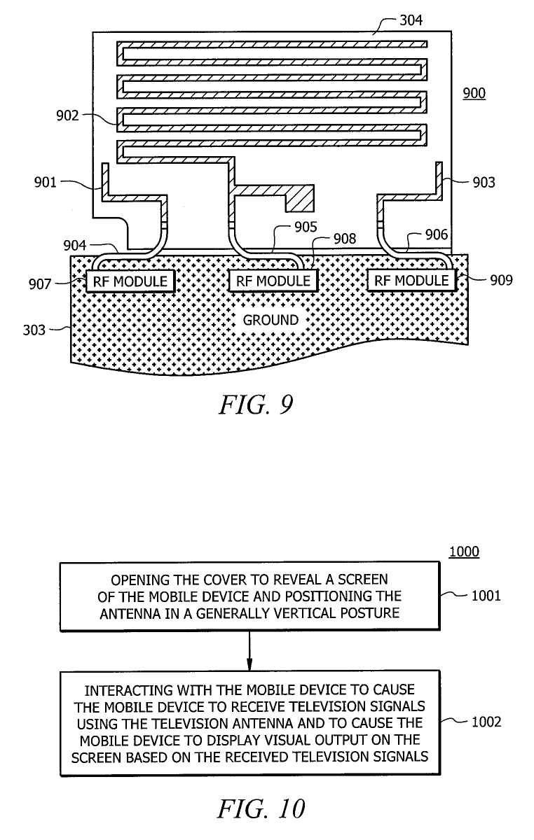

FIG. 9 is an illustration of exemplary system 900 adapted according to one embodiment of the invention. System 900 includes antenna elements 901-903, feed connections 904-906, and RF modules 907-909. In this example, antenna elements 901 and 903 have directional diversity but operate in the same band with good isolation between them, typically more than 10 dB isolation. As such, system 900 can be employed in some Multiple Input Multiple Output (MIMO) systems. For example, a multimedia system that connects to a network using IEEE 802.11n (or other technique using MIMO) can benefit from the design of system 900. In addition to having MIMO capability, system 900 can receive television and/or radio signals using antenna element 902.

Various embodiments of the invention include methods for use of systems, such as the systems illustrated in FIGS. 1-9. FIG. 10 is an illustration of exemplary method 1000, adapted according to one embodiment of the invention. In action 1001, the cover is opened to reveal a screen of the mobile device. When the cover is opened, the concealed antenna is positioned in a vertical posture. In various embodiments, exact verticality is not required, as general verticality is usually sufficient. In other words, in many embodiments, television broadcast signals are polarized such that they are best received by vertical antenna elements; however, enough verticality to receive a clear signal is usually sufficient to satisfy a human user.

In action 1002, the user interacts with the mobile device to cause the mobile device to receive television signals using the television antenna and to cause the mobile device to display visual output on the screen based on the received television signals. Action 1002 can include any of a variety of user actions, such as turning the mobile device on, selecting a channel to be received, adjusting the display settings, and the like. The user may change channels and settings and may even switch to receive content from another medium, such as from a WiFi-enabled network. When the user is done, the user may shut down the device, e.g., by powering down and closing the cover.

While method 1000 is shown as a series of discrete steps, the scope of embodiments is not so limited. Actions may be added, omitted, rearranged, and/or modified. For instance, in some embodiments, the user may open the cover and interact wirelessly with a computer or cellular telephone network before using the television function of the mobile device.

While the above description includes examples of monopole and PIFA elements, various embodiments can be adapted to employ other types of elements as well, such as dipole elements.

Various embodiments of the invention include one or more advantages over prior art solutions. For instance, external antennas for mobile devices, especially for television and radio devices, tend to be large and intrusive in a user's personal space. By contrast, some embodiments of the present invention minimize the amount of space used by external antennas, and the cover used by some embodiments is much less intrusive of a user's personal space than is an erect, wire antenna, which can even pose an eye hazard.

Furthermore, some embodiments, such as that shown in FIG. 5, are multi-polarized, which provides better multipath performance. Multi-polarization is typically not a quality of available external antennas. In other words, some embodiments provide the advantages of internal antenna systems while delivering very good television and radio reception.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A mobile device comprising:
a main compartment;
a flip cover coupled to the main compartment, wherein the main compartment includes a Radio Frequency (RF) feed and ground, and wherein said flip cover includes at least one multiband antenna system in communication with the RF feed and ground, said antenna operating in at least one television broadcast band.

2. The mobile device of claim 1 wherein said multiband antenna system operates in at least one frequency band below 300 MHz.

3. The mobile device of claim 2 wherein said multiband antenna system operates in the 174-240 MHz frequency band.

4. The mobile device of claim 1 wherein said multiband antenna system comprises:
a horizontal-vertical meander structure.

5. The mobile device of claim 1 wherein said multiband antenna system comprises:
at least one antenna element providing wireless computer network connectivity.

6. The mobile device of claim 5 wherein said wireless computer network connectivity includes connectivity according to IEEE 802.11.

7. The mobile device of claim 1 wherein said multiband antenna system comprises:
an antenna element with a plurality of slots therein.

8. The mobile device of claim 1 comprising:
a cable connecting said multi-band antenna system with said RF feed.

9. The mobile device of claim 1 comprising:
a wire trace, printed on a flexible film substrate, connecting said multi-band antenna system with said RF feed.

10. The mobile device of claim 1 wherein said multiband antenna system comprises:
a flexible film substrate.

11. The mobile device of claim 1 wherein said multiband antenna system comprises:
a connection to said ground.

12. The mobile device of claim 1 wherein said connection to said is selected from the list consisting of:
a wire trace, printed on a flexible film substrate; and
a cable.

13. The mobile device of claim 1 wherein said multiband antenna system comprises:
a plurality of diverse antenna elements providing Multiple Input Multiple Output (MIMO) performance.

14. A method for operating a mobile device, said mobile device including a cover, a main body portion with circuitry therein, and a television antenna system concealed within said cover and in communication with said circuitry in said main body portion, said method comprising:
opening said cover to reveal a screen of said mobile device and positioning said antenna in a generally vertical posture; and
interacting with said mobile device to cause said mobile device to receive television signals using said television antenna and to cause said mobile device to display visual output on said screen based on said received television signals.

15. The method of claim 14 further comprising:
interacting with said mobile device to cause said mobile device to transmit and receive communications with a wireless computer network.

16. The method of claim 15 wherein said mobile device and said wireless computer network communicate according to the IEEE 802.11 standard.

17. The method of claim 14 further comprising:
powering down said mobile device; and
closing said cover to conceal said screen.

18. A mobile television comprising:
a body portion, said body portion comprising:
a circuit board, including one or more RF modules to receive television signals;
circuits for demodulating said television signals; and
a screen for displaying visual output based upon said demodulated signals;
a hinged cover coupled to said body portion and concealing a television antenna therein, said television antenna in communication with said circuit board.

19. The mobile television of claim 18 wherein said hinged cover provides an illusion to a consumer that the mobile television does not include an external antenna.

20. The mobile television of claim 18 wherein said television antenna comprises a monopole antenna element.

21. The mobile television of claim 18 wherein said television antenna comprises a meander-line structure on a flexible film substrate.

22. The mobile television of claim 18 wherein said television antenna comprises a meander-line structure in a horizontal-vertical configuration.

23. The mobile television of claim 18 wherein said external television antenna is in communication with at least one of said one or more RF modules via a cable.

24. The mobile television of claim 18 wherein said television antenna is in communication with at least one of said one or more RF modules via a metal trace on a flexible film substrate.

25. The mobile television of claim 18 wherein said hinged cover conceals an antenna element providing wireless communications with a computer network.

26. The mobile television of claim 18 wherein said hinged cover conceals two or more diverse antenna elements each providing wireless communications with a computer network.

27. The mobile television of claim 18 wherein said television antenna comprises an external antenna.

28. The mobile television of claim 18 wherein said television antenna comprises a Planar Inverted F Antenna (PIFA) element.

29. The mobile television of claim 18 wherein said circuit board provides a ground plane for said television antenna.
